(19) United States
(12) Patent Application Publication
(10) Pub. No.: US 2017/0091127 A1
(43) Pub. Date: Mar. 30, 2017

(54) Techniques to Couple with a Storage Device via Multiple Communication Ports

(71) Applicant: Intel Corporation, Santa Clara, CA (US)

(72) Inventors: JAWAD B. KHAN, CORNELIUS, OR (US); RANDALL K. WEBB, HILLSBORO, OR (US); KELVIN D. GREEN, HILLSBORO, OR (US); BRIAN R. MCFARLANE, HILLSBORO, OR (US)

(21) Appl. No.: 14/866,310

(22) Filed: Sep. 25, 2015

(51) Int. Cl. G06F 13/16; G06F 13/42; G06F 13/10; G06F 13/40

(52) U.S. Cl. CPC G06F 13/1668; G06F 13/4068; G06F 13/4282; G06F 13/102

(57) ABSTRACT

Examples may include techniques to couple with a storage device via multiple communication ports. A first communication port at the storage device may be configurable to couple with at least one other storage device, a field programmable gate array (FPGA)/programmable logic or application-specific integrated circuit (ASIC) via a serial communication link. A second communication port at the storage device is arranged to couple with a host computing device.

### TECHNICAL FIELD

Examples described herein are generally related to a storage device including one or more memory devices or dies.

### BACKGROUND

A storage device such as a solid state drive (SSD) may include a storage controller that has logic to support one or more communication ports. These one or more communication ports may be configured for attachments of the SSD to a host computing device via respective communication links such as serial communication links. A simplified, typical SSD architecture may accept data and commands from the host computing device being transmitted via a given serial communication link to the SSD using a host communication protocol. As part of being configured for attachment of the SSD to the host computing device, the one or more communication ports may be arranged to receive the data and commands according to the host communication protocol.

### BRIEF DESCRIPTION OF THE DRAWINGS

FIG. 1 illustrates an example first system.

FIG. 2 illustrates an example second system

FIG. 3 illustrates an example third system.

FIG. 4 illustrates an example fourth system.

FIG. 5 illustrates an example fifth system.

FIG. 6 illustrates an example block diagram for an apparatus.

FIG. 7 illustrates an example of a logic flow.

FIG. 8 illustrates an example of a storage medium.

FIG. 9 illustrates an example storage device.

FIG. 10 illustrates an example computing platform.

### DETAILED DESCRIPTION

As contemplated in the present disclosure, a storage device such as an SSD may include a storage controller having one or more communication ports configured for attachment of the SSD to a host computing device. The one or more communication ports may be arranged to receive the data and commands according to the host communication protocol via a serial communication link. In some examples, the host communication protocol may include, but is not limited to, communication protocols described in industry standards or specifications (including progenies or variants) such as the Peripheral Component Interconnect (PCI) Express Base Specification, revision 3.1, published in November 2014 (“PCI Express specification” or “PCIe specification”) and/or the Non-Volatile Memory Express (NVMe) Specification, revision 1.2, also published in November 2014 (“NVMe specification”).

According to some examples, storage controllers may have logic as well as a physical configuration to support only the one or more communication ports configured for attachment to a host computing devices. Adding new communication ports that may use different or updated communication protocols than those used to support attachment to a host computing device may face an uphill effort because product development cycles for changes to some storage controllers may take several years and may be complicated to implement.

Also, in some examples, types of non-volatile memory typically included in SSDs such as NAND flash memory are becoming more affordable on a cost-per-gigabyte (GB) basis. Thus, SSDs are starting to be considered as a replacement for hard disk drives (HDDs) for cold storage applications. HDDs are currently used for cold storage applications due to current cost-per-GB advantages for HDDs compared to SSDs. For cold storage applications using SSDs, it may be desirable to pack as much storage capacity and/or SSDs in as little physical area as possible. Meanwhile, in these dense, cold storage applications a relatively low amount of communication link bandwidth (BW) for coupling to a host computing device (e.g., front-end BW) may be sufficient due to rare data writes and data reads having a somewhat modest BW requirement for the front-end BW. However, using traditional ways of attaching several SSDs in parallel provides more front-end BW than what is needed for cold storage applications. Also, switching logic may be needed for these types of parallel attachments that add additional costs and may reduce SSD densities.

Also, in some examples, if SSDs are deployed in a high density configuration some tasks or workloads traditionally implemented by processor circuitry or processors in a storage controller may be de-centralized. De-centralizing tasks or workloads may include offloading tasks to one or more field programmable gate arrays (FPGAs)/programmable logic or application-specific integrated circuits (ASICs). De-centralizing tasks or workloads may also include coordinating with other SSDs capable of sharing data via localized communication links. The coordination may be for completion of tasks or workloads received from a host computing device. Since the processing power of multiple processors at multiple storage controllers may now be available, these coordinated tasks or workloads may accommodate more complicated tasks or workloads. However, current SSDs lack an ability to de-centralize tasks as communication ports are typically configured for front-end communications that are only routed to a host computing device. It is with respect to the above-mentioned and other challenges that the examples described herein are needed.

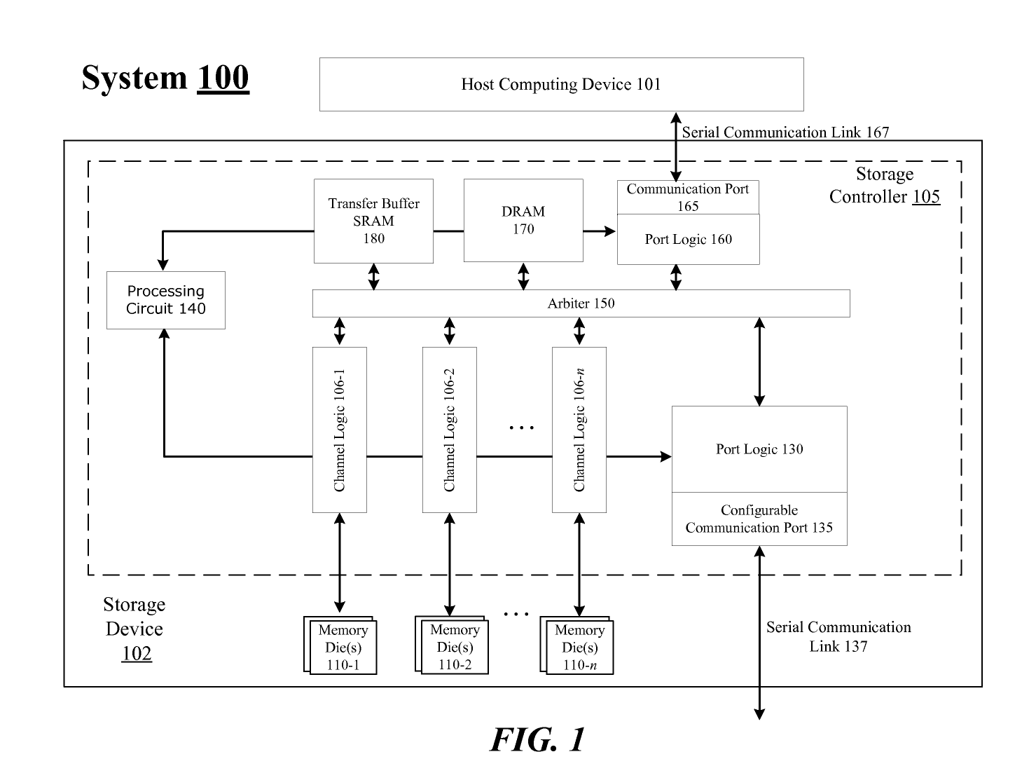

FIG. 1 illustrates an example system 100. In some examples, as shown in FIG. 1, system 100 includes a host computing device 101 coupled to a storage device 102. Also, as shown in FIG. 1, storage device 102 may include a storage controller 105 and memory die(s) 110-1 to 110-n, where “n” may be any whole positive integer greater than 1. Memory die(s) 110-1 to 110-n may represent types of non-volatile memory dies or devices arranged to store data accessible via respective memory channels controlled by respective channel logic 106-1 to 106-n of storage controller 105.

According to some examples, as shown in FIG. 1, storage controller 105 includes a processing circuit 140 to support logic and/or features to facilitate reading, modifying or writing to memory die(s) 110-1 to 110-n responsive to commands received from host computing device 101 or generated by internal firmware of storage controller 105. The supported logic and/or features may include channel logic 106-1, port logic 130, arbiter 150 or port logic 160. For these examples, a dynamic random access memory (DRAM) 170 and/or a transfer buffer static random access memory (SRAM) may also facilitate reading, modifying or writing to memory die(s) 110-1 to 110-n.

In some examples, as described more below, a storage device such as storage device 102 may have a storage controller such as storage controller 105. The storage controller of the storage device may include first port logic such as port logic 160 at a first communication port such as communication port 165. The first communication port may be arranged to couple to host computing device such as host computing device 101 via a serial communication link such as serial communication link 167. For these examples, the storage controller of the storage device may include second port logic such as port logic 130 at a second communication port such as communication port 135. The second port logic may be capable of configuring the second communication port to couple in communication with at least one other storage device, an FPGA/programmable logic or an ASIC. The second port logic may also be capable of communicating directly with the at least one other storage device, FPGA/programmable logic or ASIC responsive to an indication the at least one other storage device, FPGA/programmable logic or ASIC has coupled through the second communication port.

According to some examples, communication port 165 may be arranged to use a communication protocol described in the PCIe specification (“PCIe communication protocol”) and/or the NVMe specification (“NVMe communication protocol”) in order to couple in communication with host computing device 101 via serial communication link 167. For these examples, port logic 160 may operate communication port 165 as a PCIe end point as perceived by host computing device 101.

In some examples, configurable communication port 135 may be arranged to also use the PCI communication protocol and/or the NVMe communication protocol in order to couple with at least one other storage device, FPGA/programmable logic or ASIC via serial communication link 137. As described more below, depending what device or type of storage device configuration is coupled via a serial communication link such as serial communication link 137, a port logic such as port logic 130 may configure a communication port such as configurable communication port 135 as either a PCIe end point or as a PCIe root port.

According to some examples, configurable communication port 135 may be arranged to also use a different communication protocol than used at communication port 165 in order to couple with at least one other storage device, FPGA/programmable logic or ASIC via serial communication link 137. For these examples, the different communication protocol may include any type of relatively fast serial communication protocol such as, but not limited to, an Ethernet communication protocol, a quickpath interconnect (QPI) communication protocol, an Infiniband communication protocol or a universal serial bus (USB) communication protocol. The Ethernet communication protocol may be according to one or more Ethernet standards promulgated by the Institute of Electrical and Electronics Engineers (IEEE) such as IEEE 802.3-2012, Carrier sense Multiple access with Collision Detection (CSMA/CD) Access Method and Physical Layer Specifications, Published in December 2012. The QPI communication protocol may be according to Intel® QuickPath Interconnect technology. The Infiniband communication protocol may be according to the Infiniband™ Architecture Specification, Vol. 2, Rel. 1.3, published November 2012. The USB communication protocol may be according to USB 3.1, published in July 2013.

In some examples, communication port 165 may be arranged to operate with other types of communication protocols besides PCIe and/or NVMe to communicate or coupled with host computing device 101 via serial communication link 167. For example, communication port 165 may be arranged to operate using a Serial Advanced Technology Attachment (SATA) communication protocol as described in SATA, revision 3.2, published in August 2013 or using a Serial Attached Small Computer System Interface (SCSI) (or simply SAS) communication protocol as described in SAS-3, published in March 2013. For these examples, configurable communication port 135 may be arranged to operate with the same SATA, same SAS or different communication protocols as those used for communication port 165. Use of different communication protocols, for example, may be used during direct communications between storage device or between a storage device and an FPGA/programmable logic or ASIC.

According to some examples, other non-volatile types of memory in addition to NAND memory may be included in memory die(s) 110-1 to 110-n of storage device 102. For these examples, the other types of non-volatile memory may include, but are not limited to, three dimensional (3D) cross-point memory, NOR flash memory, ferroelectric memory, silicon-oxide-nitride-oxide-silicon (SONOS) memory, polymer memory such as ferroelectric polymer memory, nanowire, ferroelectric transistor random access memory (FeTRAM or FeRAM), ovonic memory, nanowire, electrically erasable programmable read-only memory (EEPROM), phase change memory, memristers or spin transfer torque-magnetoresistive random access memory (STT-MRAM).

In some examples, serial communication link 167 and/or serial communication link 137 may be routed through cables, routed via traces in a printed circuit board, routed through pins in plugs or via a combination of cable, traces or pins in plugs. Also, various transport mediums including electrical or optical transport mediums may be utilized for serial communication links 167 and/or 137.

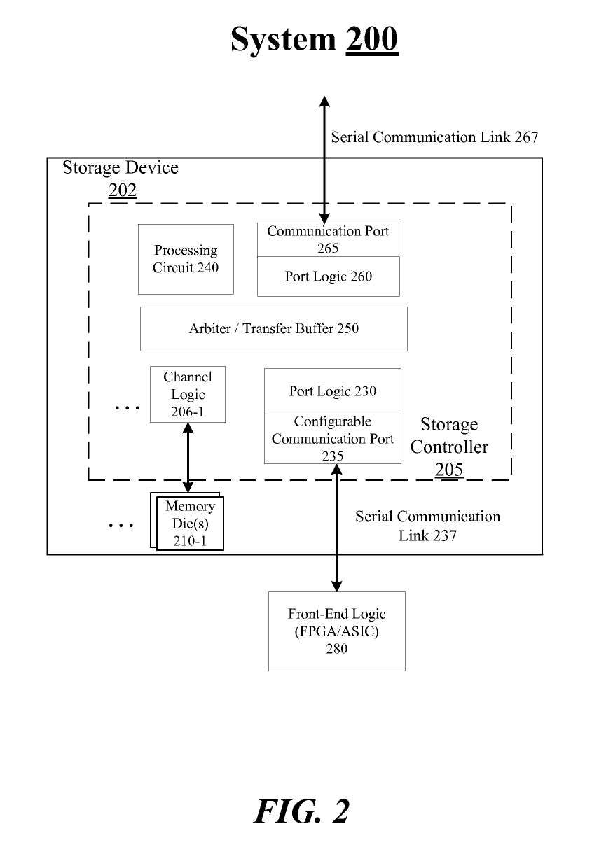

FIG. 2 illustrates an example system 200. In some examples, as shown in FIG. 2, system 200 includes a storage device 202 having a storage controller 205. Also, as shown in FIG. 2, storage controller 205 includes similar elements to storage controller 105 shown in FIG. 1. For example, storage controller 205 includes a processing circuit 240, an arbiter/transfer buffer 250, port logic 230 for a configurable communication port 235 or port logic 260 for a communication port 265. Storage controller 205 is shown in FIG. 2 as including a channel logic 206-1 that may facilitate reading, modifying or writing to memory die(s) 210-1. Although not shown in FIG. 2, additional channel logic for multiple channels to additional memory die(s) may be included in storage device 202.

According to some examples, port logic 230 may be able to configure configurable communication port 235 to couple with front-end logic 280 via serial communication link 237. Front-end logic 280 may be an FPGA/programmable logic or ASIC to enable storage device 202 to communicate through communication port 265 via serial communication link 267 using a communication protocol not supported by logic included in storage controller 205. For examples, port logic 260 may be capable of supporting only the PCIe and/or NVMe communication protocols. However, front-end logic 280 may provide additional front-end logic capable of handling other communication protocols such as, but not limited to Ethernet, QPI, Infiniband, USB, SATA or SAS communication protocols for communications through communication port 265 via serial communication link 267.

In some examples, front-end logic 280 may enable new front-end protocols to be used in addition to those supported by logic of storage controller 205. This may be useful in making additional protocol logic available for possible pathfinding to prove a concept of new front-end protocols without completely or at least partially redesigning a storage controller. In some examples, an FPGA/programmable logic may be first used to test different communication protocols. Once a communication protocol has been proven effective, logic from the FPGA/programmable logic may be moved to a standalone ASIC that may be moved to be within the storage device.

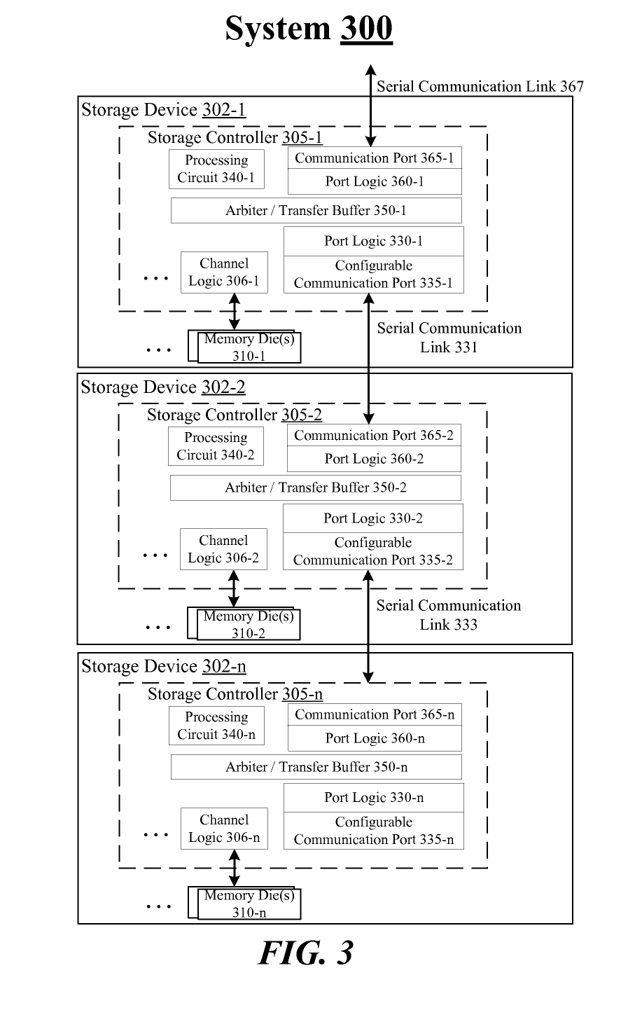

FIG. 3 illustrates an example system 300. In some examples, as shown in FIG. 3, system 300 includes a storage devices 302-1 to 302-n each having respective storage controllers 305-1 to 305-n. Also, as shown in FIG. 3, storage controllers 305-1 to 305-n include similar elements to storage controllers 105 or 205 shown in FIGS. 1 and 2. For example, storage controllers 305-1 to 305-n include processing circuits 340-1 to 340-n, arbiters/transfer buffers 350-1 to 350-n, port logic 330-1 to 330-n for respective configurable communication ports 335-1 to 335-n or port logic 360-1 to 360-n for respective communication ports 365-1 to 365-n. Storage controllers 305-1 to 305-n is shown in FIG. 3 as including channel logic 306-1 to 306-n to facilitate reading, modifying or writing to respective memory die(s) 310-1 to 310-n. Although not shown in FIG. 3, additional channel logic for multiple channels to additional memory die(s) may be included in each storage device 302-1 to 302-n.

In some examples, system 300 illustrates an example of multiple storage devices creating a chain of storage devices. This type of configuration may be useful for cold storage applications where data writes may be rare and data reads may have a modest BW requirement. In other words, BW provided through communication port 365-1 of storage device 302-1 at the top of the chain via serial communication link 367 may be adequate for cold storage applications that may chain multiple storage devices allowing for a large amount of storage capacity to be accessed by a host computing device when coupled to storage device 302-1 through communication port 365-1 via serial communication link 367. Chaining in the configuration shown in FIG. 3 may also eliminate a need for switching circuitry if the multiple storage devices were instead configured in a parallel access configuration that would include the host computing device coupling directly to storage devices 320-1 to 320-n via separate serial communication links.

According to some examples, port logic included in storage controllers 305-1 to 305-n may each be capable of communicating through each communication port using PCIe communication protocols. For these examples, port logic 360-1 may be capable of receiving communications (e.g., commands) from a host computing device through communication port 365-1 that may cause the host computing device to treat or interact with storage device 302-1 as a PCIe end point while the host computing device includes the PCI root port. However, port logic 335-1 may be capable of configuring configurable communication port 335-1 to interact with storage device 302-2 such that configurable communication port 335-1 serves as the root port for communications routed via serial communication link 331 through communication port 365-2. Further, port logic 335-2 may capable of configuring configurable communication port 335-2 to then interact with the next storage device in the chain that is shown in FIG. 3 as storage device 302-n such that configurable communication port 335-2 serves as the root port for communications routed via serial communication link 333 through communication port 365-n. Since storage device 302-n is the end of the chain, there is no need for configuring configurable communication port 335-5 and it is not used in this example. However, should another storage device later couple with storage device 302-3 via configurable communication port 335-5 this communication port may be configured as a root port for this other storage device coupling.

Examples are not limited to use of PCIe communication protocols for chaining of multiple storage devices as shown in FIG. 3. Other communication protocols may include, but are not limited to, NVMe, QPI, Ethernet, Infiniband or USB communication protocols.

In some examples, storage device 302-1 is coupled with a host computing device (not shown) via serial communication link 367. As the first storage device coupled to the host computing device, storage device 302-1 may query the storage device down the chain to gather chain information for use by the host computing device to access or use these storage devices. The chain information may be created at each level of the chain by a given storage device querying a storage device below it and passing any subsequent chain information received by this querying to a storage device above it in the chain.

According to some examples, storage device 302-1 may be responsible for sending all commands received from the host computing device through communication port 365-1 which are not destined or addressed to storage device 302-1 to storage devices below it in the chain. For these examples, the next storage device in the chain may keep forwarding the command until the command has reached the addressed storage device. Similarly, a response and/or data generated or provided by an addressed storage device for a command from the host computing device (e.g., originating from a host processor) may move up the chain until it is sent through communication port 365-1 of storage device 302-1 to be received by the host computing device via serial communication link 367.

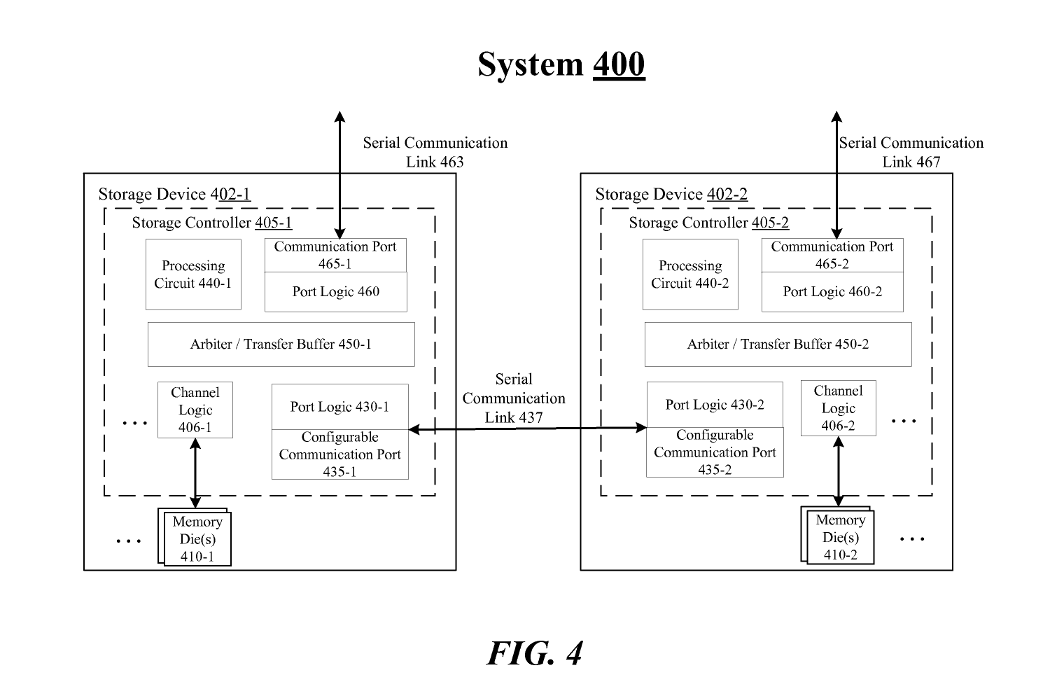

FIG. 4 illustrates an example system 400. In some examples, as shown in FIG. 4, system 400 includes a storage devices 402-1 to 402-2 each having respective storage controllers 405-1 to 405-2. Also, as shown in FIG. 4, storage controllers 405-1 to 405-2 include similar elements to storage controllers 105, 205 or 305-1 to 305-n shown in FIGS. 1-3. For example, storage controllers 405-1 to 405-2 include processing circuits 440-1 to 440-2, arbiters/transfer buffers 450-1 to 450-2, port logic 430-1 to 430-2 for respective configurable communication ports 435-1 to 435-2 or port logic 460-1 to 460-2 for respective communication ports 465-1 to 465-2. Storage controllers 405-1 to 405-2 is shown in FIG. 4 as including channel logics 406-1 to 405-2 to facilitate reading, modifying or writing to respective memory die(s) 410-1 to 410-2. Although not shown in FIG. 4, additional channel logic for multiple channels to additional memory die(s) may be included in each storage device 402-1 to 402-2.

In some examples, system 400 illustrates an example of direct communications between storage devices 402-1 and 402-2 via serial communication link 437 without need to route communications through a host computing device or system (not shown) that may couple separately to storage devices 402-1 via serial communication link 463 and to storage devices 402-2 via serial communication link 467. Also, port logic 430-1 and port logic 430-2 may be capable of configuring their respective configurable communication ports 435-1 and 435-2 to operate using different communication protocols that those used for operating communication ports 465-1 and 465-2 arranged to couple with the host computing device. For example, communication ports 465-1 and 465-2 may operate using PCIe and/or NVMe communication protocols. Meanwhile configurable communication ports 435-1 or 435-2 may operate using an Ethernet, a QPI, an Infiniband or a USB communication protocol. Thus, serial communication link 437 may serve as off-band communication link between storage device 402-1 and storage device 402-2. As an off-band communication link, serial communication links 463 and 467 may be freed up for just input/output operations to respective memory die(s) 410-1 and 410-2.

According to some examples, direct communications between multiple storage devices may allow a group of computation capable storage devices to share workloads between one another and thus increase parallelization to handle more complex workloads. Coordination may occur to complete such workloads such as, but not limited to, a filter operation or a search string for data stored to one or more of the memory devices or dies maintained at one or at least some of the multiple storage devices.

Although FIG. 4 shows two storage devices coupled together, one or both storage devices may include multiple configurable communication ports to extend the two-link horizontal configuration of system 400 to any number of links.

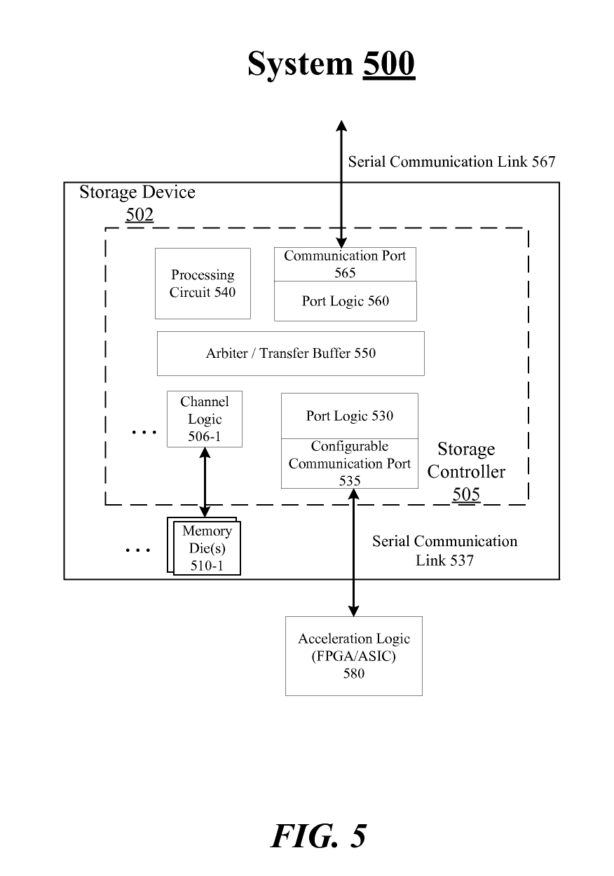

FIG. 5 illustrates an example system 500. In some examples, as shown in FIG. 5, system 500 includes a storage device 502 having a storage controller 505. Also, as shown in FIG. 5, storage controller 505 includes similar elements to storage controllers 105 and 205 shown in FIGS. 1 and 2. For example, storage controller 505 includes a processing circuit 540, and arbiter/transfer buffer 550, port logic 530 for a configurable communication port 535 or port logic 560 for a communication port 565. Storage controller 505 is shown in FIG. 5 as including a channel logic 506-1 that facilitate reading, modifying or writing to memory die(s) 510-1. Although not shown in FIG. 5, additional channel logic for multiple channels to additional memory die(s) may be included in storage device 502.

In some examples, acceleration logic 580 couples to storage controller 505 through configurable communication port 535 via serial communication link 537. Acceleration logic 580 may be an FPGA/programmable logic or ASIC configured for hardware acceleration of certain storage related tasks or workloads that may be offload from storage controller 505. These storage related tasks may include, but are not limited to, encryption of data written to memory die(s) 510-1, decryption of encrypted data read from memory die(s) 510-1, compression of data written to memory die(s) 510-1, decompression of compressed data read from memory die(s) 510-1, a filter operation on data stored in memory die(s) 510-1 or a search string associated with data stored in memory die(s) 510-1.

According to some examples, a command may be received from a host computing device through communication port 565 via serial communication link 567 that indicates a workload to be performed on data to be written to or read from memory die(s) 510-1. For these examples, processing circuit 540 may decide to offload at least a portion of the workload to acceleration logic 580 and may also direct port logic 530 to configure configurable communication port 535 to facilitate communication of the workload via serial communication link 537 and to allow acceleration logic to access memory die(s) 510 to complete at least its offloaded portion of the workload. A same or different communication protocol as used at communication port 565 may be used at configurable communication port 535. For example, communication port 565 may use the PCIe communication protocol. Meanwhile, configuration communication port 535 may either use the PCIe communication protocol or may be configured to use one of the Ethernet, QPI, Infiniband or USB communication protocols.

In some examples, acceleration logic 580 may be housed within storage device 502. In other examples, acceleration logic 580 may couple to storage device as a peripheral device outside of storage device 502.

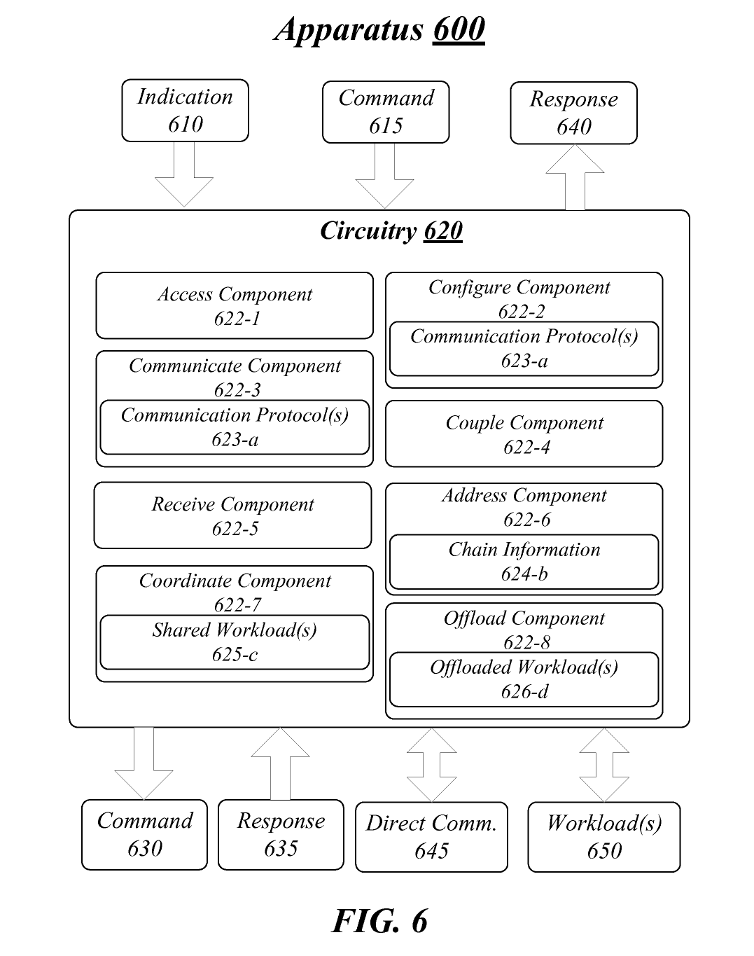

FIG. 6 illustrates an example block diagram for an apparatus 600. Although apparatus 600 shown in FIG. 6 has a limited number of elements in a certain topology, it may be appreciated that the apparatus 600 may include more or less elements in alternate topologies as desired for a given implementation.

The apparatus 600 may be supported by circuitry 620 maintained at a storage device similar to storage devices 102, 202, 302, 402 or 502 of systems 100, 200, 300, 400 or 500 shown in FIGS. 1-5. The storage device may be coupled to a host computing device similar to host computing device 101 also shown in FIG. 1. Also, as mentioned above, the storage device may include one or more memory devices or dies, a first communication port arranged to couple with the host computing device, a second communication port (configurable) and a storage controller. Circuitry 620 may be arranged to execute one or more software or firmware implemented components or modules 622-a (e.g., implemented, at least in part, by a storage controller of a storage device). It is worthy to note that “a” and “b” and “c” and similar designators as used herein are intended to be variables representing any positive integer. Thus, for example, if an implementation sets a value for a=8, then a complete set of software or firmware for components or modules 622-a may include components 622-1, 622-2, 622-3, 622-4, 622-5, 622-6, 622-7 or 622-8. The examples presented are not limited in this context and the different variables used throughout may represent the same or different integer values.

According to some examples, circuitry 620 may include a processor or processor circuitry. The processor or processor circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also include one or more application-specific integrated circuits (ASICs) and at least some components 622-a may be implemented as hardware elements of these ASICs.

According to some examples, apparatus 600 may include an access component 622-1. Access component 622-1 may be executed by circuitry 620 to control access to one or more memory devices or dies maintained at the storage device that includes apparatus 600.

In some examples, apparatus 600 may also include a configure component 622-2. Configure component 622-2 may be executed by circuitry 620 to configure the second communication port to couple in communication with at least one other storage device, an FPGA/programmable logic or an ASIC. For these examples, configure component 622-2 may maintain communication protocol(s) 623-a (e.g., in a lookup table (LUT) to configure the second communication port for communication with the at least one other storage device, the FPGA/programmable logic or the ASIC.

According to some examples, apparatus 600 may also include a communicate component 622-3. Communicate component 622-3 may be executed by circuitry 620 to communicate directly with the at least one other storage device, FPGA/programmable logic or ASIC responsive to an indication that the at least one other storage device, FPGA/programmable logic or ASIC has coupled through the second communication port. Communication component 622-3 may maintain or have access to communication protocol(s) 623-a to facilitate direct communications that are shown in FIG. 6 as direct communications 645. Direct communications may include sharing or offloading workloads or tasks between storage devices, FPGA/programmable logics or ASICs.

In some examples, apparatus 600 may also include a couple component 622-4. Couple component 622-4 may be executed by circuitry 620 to receive a first indication that either a first other storage device, a first FPGA/programmable logic or first ASIC has coupled through the second communication port. For these examples, the indication of the coupling may be included in indication 610 and may include, for example, a drop in impedance in a monitored pin or trace wire maintained in the second communication port.

According to some examples, apparatus 600 may also include a receive component 622-4. Receive component 622-4 may be executed by circuitry 620 to receive a command from the host computing device through the first communication port of the storage device including apparatus 600. For these examples, the command may be included in command 615.

In some examples, apparatus 600 may also include an address component 622-5. Address component 622-5 may be executed by circuitry 620 to determine the address or destination for the command received by receive component 622-2. According to some examples, the address may be for a first other storage device coupled through the second communication port or may be a second other storage device coupled through a communication port included at the first other storage device. For these examples, address component 622-2 may maintain chain information 624-b (e.g., in a LUT) to determine what storage device to forward the command to through the second communication port via a first serial communication link that may couple the storage device to the first other storage device. Address component 622-5 may also use chain information included in chain information 624-b to forward responses included in responses 635 to forwarded commands included in commands 630. The forwarded responses may be included in responses 640.

According to some examples, apparatus 600 may also include a coordinate component 622-7. Coordinate component 622-7 may be executed by circuitry 620 to coordinate with storage devices coupled with the storage device including apparatus 600 to share the workload indicated in the command included in command 615. For these examples, the coordination may occur through the second communication port via the first serial communication link and through a third communication port at the first other storage device. Coordination information may be included in direction communication 645. Also, coordinate component may maintain information to track shared workloads or tasks in shared workload(s) 625-c (e.g., in a LUT).

In some examples, apparatus 600 may also include an offload component 622-8. Offload component 622-8 may be executed by circuitry 620 to offload at least a portion of a workload to a first FPGA/programmable logic or first ASIC. For these examples, the workload may be included in workload(s) 650. Also, offload component 622-8 may maintain information in offloaded workload(s) 626-d (e.g., in a LUT) to track workloads or tasks that may have been offloaded.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

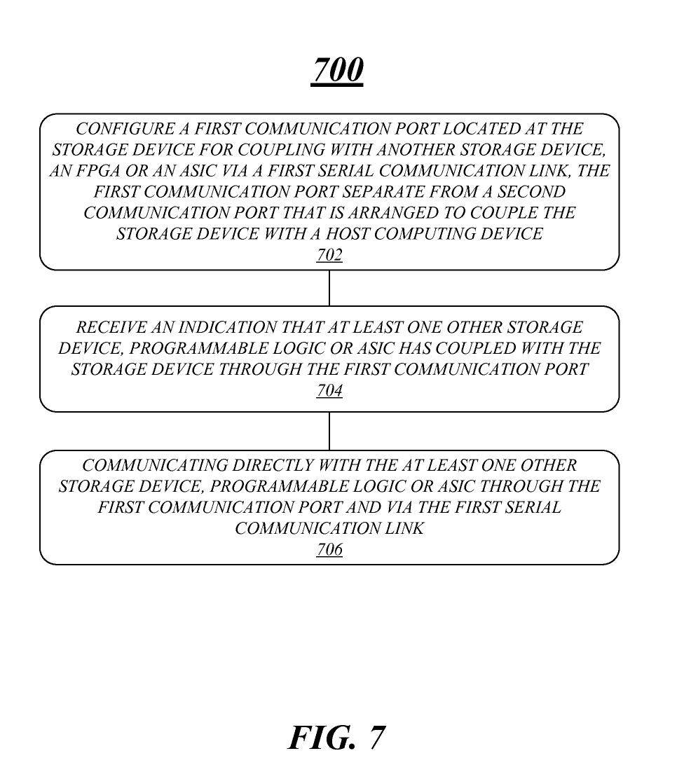

FIG. 7 illustrates an example of a logic flow 700. Logic flow 700 may be representative of some or all of the operations executed by one or more logic, features, or devices described herein, such as apparatus 600. More particularly, logic flow 700 may be implemented by one or more of access component 622-1, configure component 622-2, communicate component 622-3 couple component 622-4, receive component 622-5, address component 622-6, coordinate component 622-7 or offload component 622-8.

According to some examples, logic flow 700 at block 702 may configure a first communication port located at the storage device for coupling with another storage device, an FPGA/programmable logic or an ASIC via a first serial communication link, the first communication port separate from a second communication port that is arranged to couple the storage device with a host computing device. For these examples, configure component 622-2 may configure the first communication port located at the storage device.

In some examples, logic flow 700 at block 704 may receive an indication that at least one other storage device, FPGA/programmable logic or ASIC has coupled with the storage device through the first communication port. For these examples, couple component 622-4 may receive the indication.

According to some examples, logic flow 700 at block 706 may communicate directly with the at least one other storage device, FPGA/programmable logic or ASIC through the first communication port and via the first serial communication link. For these examples, communicate component 622-3 may communicate directly with the at least one other storage device, FPGA/programmable logic or ASIC.

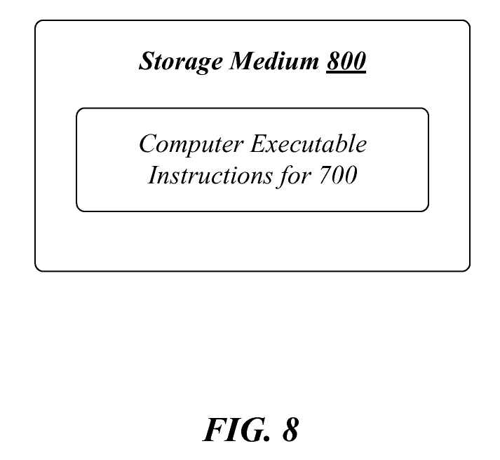

FIG. 8 illustrates an example of a first storage medium. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

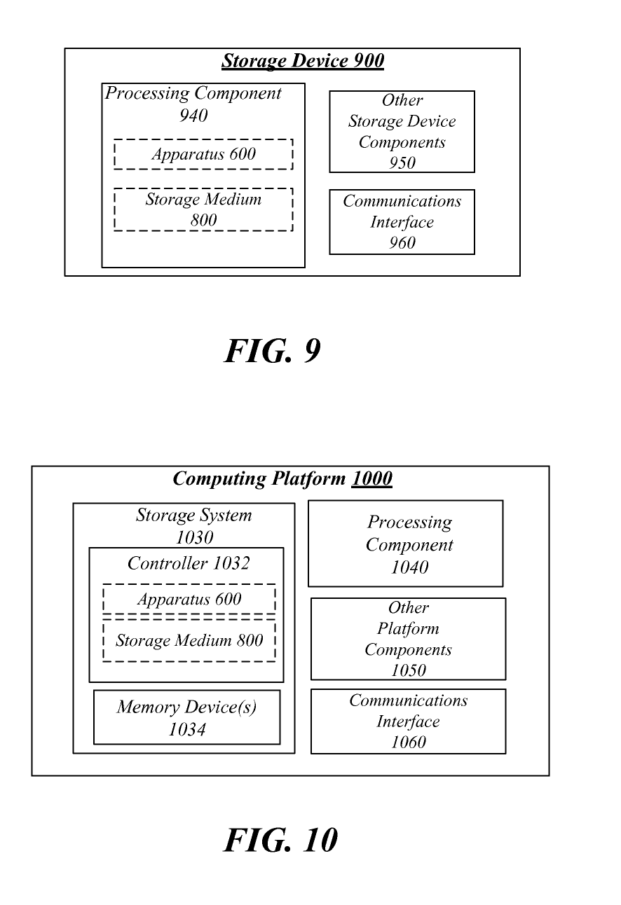

FIG. 9 illustrates an example storage device 900. In some examples, as shown in FIG. 9, storage device 900 may include a processing component 940, other storage device components 950 or a communications interface 960. According to some examples, storage device 900 may be capable of being coupled to a host computing device as mentioned previously.

According to some examples, processing component 940 may execute processing operations or logic for apparatus 600 and/or storage medium 800. Processing component 940 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other storage device components 950 may include common computing elements or circuitry, such as one or more processors, multi-core processors, co-processors, memory units, chipsets, controllers, interfaces, oscillators, timing devices, power supplies, and so forth. Examples of memory units may include without limitation various types of computer readable and/or machine readable storage media in the form of one or more higher speed memory units, such as read-only memory (ROM), random-access memory (RAM), dynamic RAM (DRAM), Double-Data-Rate DRAM (DDR DRAM), synchronous DRAM (SDRAM), DDR SDRAM, static RAM (SRAM), programmable ROM (PROM), erasable programmable ROM (EPROM), electrically erasable programmable ROM (EEPROM), flash memory, ferroelectric memory, silicon-oxide-nitride-oxide-silicon (SONOS) memory, polymer memory such as ferroelectric polymer memory, nanowire, ferroelectric transistor random access memory (FeTRAM or FeRAM), ovonic memory, nanowire, electrically erasable programmable read-only memory (EEPROM), phase change memory, memristers or spin transfer torque-magnetoresistive random access memory (STT-MRAM), magnetic or optical cards, and any other type of storage media suitable for storing information.

In some examples, communications interface 960 may include logic and/or features to support a communication interface. For these examples, communications interface 960 may include one or more communication interfaces that operate according to various communication protocols or standards to communicate over direct or network communication links. Direct communications may occur via use of communication protocols such as SMBus, PCIe, NVMe, QPI, SATA, SAS or USB communication protocols. Network communications may occur via use of communication protocols Ethernet, Infiniband, SATA or SAS communication protocols.

Storage device 900 may be arranged as an SSD that may be configured as described above for systems 100, 200, 300, 400 or 500 shown in FIGS. 1-5. Accordingly, functions and/or specific configurations of storage device 900 described herein, may be included or omitted in various embodiments of storage device 900, as suitably desired.

The components and features of storage device 900 may be implemented using any combination of discrete circuitry, ASICs, logic gates and/or single chip architectures. Further, the features of storage device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example storage device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

FIG. 10 illustrates an example computing platform 1000. In some examples, as shown in FIG. 10, computing platform 1000 may include a storage system 1030, a processing component 1040, other platform components 1050 or a communications interface 1060. According to some examples, computing platform 1000 may be implemented in a computing device.

According to some examples, storage system 1030 may be similar to systems 100, 200, 300, 400 or 500 and includes a controller 1032 and memory devices(s) 1034. For these examples, logic and/or features resident at or located at controller 1032 may execute at least some processing operations or logic for apparatus 600 and may include storage media that includes storage medium 800. Also, memory device(s) 1034 may include similar types of volatile or non-volatile memory (not shown) that are described above for storage device 900 shown in FIG. 9.

According to some examples, processing component 1040 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, PLD, DSP, FPGA/programmable logic, memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1050 may include common computing elements, such as one or more processors, multi-core processors, co-processors, memory units, chipsets, controllers, peripherals, interfaces, oscillators, timing devices, video cards, audio cards, multimedia I/O components (e.g., digital displays), power supplies, and so forth. Examples of memory units associated with either other platform components 1050 or storage system 1030 may include without limitation, various types of computer readable and machine readable storage media in the form of one or more higher speed memory units, such as ROM, RAM, DRAM, DDRAM, SDRAM, SRAM, PROM, EPROM, EEPROM, flash memory, ferroelectric memory, silicon-oxide-nitride-oxide-silicon (SONOS) memory, polymer memory such as ferroelectric polymer memory, nanowire, ferroelectric transistor random access memory (FeTRAM or FeRAM), ovonic memory, nanowire, electrically erasable programmable read-only memory (EEPROM), phase change memory, memristers or spin transfer torque-magnetoresistive random access memory (STT-MRAM), magnetic or optical cards, an array of devices such as RAID drives, solid state memory devices, SSD and any other type of storage media suitable for storing information.

In some examples, communications interface 1060 may include logic and/or features to support a communication interface. For these examples, communications interface 1060 may include one or more communication interfaces that operate according to various communication protocols or standards to communicate over direct or network communication links. Direct communications may occur through a direct interface via use of communication protocols or standards described in one or more industry standards (including progenies and variants) such as those associated with the SMBus specification, the PCIe specification, the NVMe specification, the SATA specification, SAS specification or the USB specification. Network communications may occur through a network interface via use of communication protocols or standards such as those described in one or more Ethernet standards promulgated by the IEEE. For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”).

Computing platform 1000 may be part of a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 1000 described herein, may be included or omitted in various embodiments of computing platform 1000, as suitably desired.

The components and features of computing platform 1000 may be implemented using any combination of discrete circuitry, ASICs, logic gates and/or single chip architectures. Further, the features of computing platform 1000 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include one or more memory devices. The apparatus may also include a first communication port arranged to couple with a host computing device/The apparatus may also include a second communication port and a storage controller that includes logic, at least a portion of which is in hardware. The logic may control access to the one or more memory devices. The logic may also configure the second communication port to couple in communication with at least one other storage device, programmable logic or an ASIC. The logic may also communicate directly with the at least one other storage device, programmable logic or ASIC responsive to an indication that the at least one other storage device, programmable logic or ASIC has coupled through the second communication port.

### Example 2

The apparatus of example 1 may include the first and second communication ports arranged to use a same communication protocol. For these examples, the same communication protocol may include a PCIe or an NVMe communication protocol.

### Example 3

The apparatus of example 1, the first and second communication ports may be arranged to use different serial communication protocols. The second communication port may be arranged to use a first serial communication protocol including one of an Ethernet communication protocol, a QPI communication protocol, an Infiniband communication protocol or a USB communication protocol. The first communication port may be arranged to use a second communication protocol including a PCIe or an NVMe communication protocol.

### Example 4

The apparatus of example 1, the logic may also receive a first indication that a first other storage device has coupled through the second communication port.

### Example 5

The apparatus of example 4, the first other storage device may have a third communication port configured such that the first other storage device is capable of coupling to the host computing device or to the storage device through the third communication port. The logic to communicate directly with the at least one other storage device includes the logic to communicate directly with the first other storage device through the second communication port, via the first serial communication link and through the third communication port.

### Example 6

The apparatus of example 5, the logic may also receive a command from the host computing device through the first communication port. The logic may also determine the command is addressed to the first other storage device. The logic may also forward the command to the first other storage device through the second communication port via the first serial communication link.

### Example 7

The apparatus of example 5, the first other storage device may have a fourth communication port configured such that the first other storage device is capable of coupling to a second other storage device through the fourth communication port via a second serial communication link responsive to the second other storage device coupling via the second serial communication link. The logic may also receive a second indication that the second other storage device has coupled to the first other storage devices. The logic may also communicate directly with the at least one other storage device includes the logic to communicate directly with the second other storage device through the second communication port via the first serial communication link and through the third communication port then through the fourth communication port via the second serial communication link.

### Example 8

The apparatus of example 7, the second other storage device may have a fifth communication port configured such that the second other storage device is capable of coupling to the host computing device or to the second other storage device through the fifth communication port via the second serial communication link.

### Example 9

The apparatus of example 8, the logic may also receive a command from the host computing device via the first communication port. The logic may also determine the command is addressed to the second other storage device. The logic may also forward the command to the first other storage device through the second communication port via the first serial communication link, the command then forwarded by the first other storage device to the second other storage device through the fourth communication port via the second serial communication link.

### Example 10

The apparatus of example 4, the first other storage device may have a third communication port configured to directly couple with the storage device through the second communication port via a first serial communication link. For these examples, the logic to communicate directly with the at least one other storage device includes the logic to communicate directly with the first other storage device through the second communication port, via the first serial communication link and through the third communication port at the first other storage device.

### Example 11

The apparatus of example 10, the logic may also receive a command from the host computing device indicating a workload. The logic may also coordinate with the first other storage device to share the workload indicated in the command. The coordination may occur via direct communications through the second communication port, via the first serial communication link and through the third communication port at the first other storage device.

### Example 12

The apparatus of example 11, the workload may include a filter operation or a search string for data stored to the one or more memory devices and stored to at least one memory device maintained at the first other storage device.

### Example 13

The apparatus of example 1, the logic to may also receive an indication that a first programmable logic has coupled through the second communication port.

### Example 14

The apparatus of example 13, the first programmable logic may include a front-end logic to enable the storage device to communicate through the first communication port using a communication protocol not supported by a storage controller logic for the storage device.

### Example 15

The apparatus of example 14, the communication protocol may include one of an Ethernet communication protocol, a QPI communication protocol or an Infiniband communication protocol.

### Example 16

The apparatus of example 1, the logic may also receive an indication that a first ASIC has coupled through the second communication port.

### Example 17

The apparatus of example 16, the logic may also receive a command from the host computing device that indicates a workload to be performed on data to be written to or read from the one or more memory devices. The logic may also offload at least a portion of the workload to the first ASIC, the at least a portion of the workload to include encryption of the data, decryption of the data, compression of the data, decompression of the data, a filter operation on the data or a search string associated with the data.

### Example 18

The apparatus of example 1, the one or more memory devices may include one or more types of non-volatile memory to include 3D cross-point memory, flash memory, ferroelectric memory, SONOS memory, polymer memory, ferroelectric polymer memory. FETRAM, FeRAM, ovonic memory, nanowire, EEPROM, phase change memory, memristers or STT-MRAM.

### Example 19

An example method may be implemented at a storage device. The method may include configuring, at a processor circuit, a first communication port located at the storage device for coupling with another storage device, programmable logic or an ASIC via a first serial communication link, the first communication port separate from a second communication port that is arranged to couple the storage device with a host computing device. The method may also include receiving an indication that at least one other storage device, programmable logic or ASIC has coupled with the storage device through the first communication port. The method may also include communicating directly with the at least one other storage device, programmable logic or ASIC through the first communication port and via the first serial communication link.

### Example 20

The method of example 19, the first and second communication ports may be arranged to use a same communication protocol. For these examples, the same communication protocol may include a PCIe or an NVMe communication protocol.

### Example 21

The method of example 19, the first and second communication ports may be arranged to use different serial communication protocols. The first communication port may be arranged to use a first serial communication protocol including one of an Ethernet communication protocol, a QPI communication protocol, an Infiniband communication protocol or a USB communication protocol. The second communication port may be arranged to use a second communication protocol including a PCIe or an NVMe communication protocol.

### Example 22

The method of example 19, receiving the indication that at least one other storage device, programmable logic or ASIC has coupled with the storage device through the first communication port may include receiving a first indication that a first other storage device has coupled through the first communication port.

### Example 23

The method of example 22, comprising the first other storage device having a third communication port configured such that the first other storage device is capable of coupling to the host computing device or to the storage device through the third communication port. Communicating directly with the at least one other storage device may include the storage device communicating directly with the first other storage device through the first communication port, via the first serial communication link and through the third communication port.

### Example 24

The method of example 23 may also include receiving a command from the host computing device through the second communication port. The method may also include determining the command is addressed to the first other storage device. The method may also include forwarding the command to the first other storage device through the first communication port via the first serial communication link.

### Example 25

The method of example 23, the first other storage device may have a fourth communication port configured such that the first other storage device is capable of coupling to a second other storage device through the fourth communication port via a second serial communication link responsive to the second other storage device coupling via the first serial communication link. For these examples, communicating directly with the at least one other storage device may include receiving a second indication that the second other storage device has coupled to the first other storage device. Communication directly may also include communicating directly with the second other storage device through the first communication port via the first serial communication link and through the third communication port then through the fourth communication port via the second serial communication link.

### Example 26

The method of example 25, the second other storage device may have a fifth communication port configured such that the second other storage device is capable of coupling to the host computing device or to the second other storage device through the fifth communication port via the second serial communication link.

### Example 27

The method of example 26 may also include receiving a command from the host computing device via the second communication port. The method may also include determining the command is addressed to the second other storage device. The method may also include forwarding the command to the first other storage device through the first communication port via the first serial communication link, the command then forwarded by the first other storage device to the second other storage device through the fourth communication port via the second serial communication link.

### Example 28

The method of example 22, the first other storage device having a third communication port configured to directly couple with the storage device via the first serial communication link. For these examples, communicating directly with the at least one other storage device may include the storage device communicating directly with the first other storage device through the first communication port, via the first serial communication link and through the third communication port at the first other storage device.

### Example 29

The method of example 28 may also include receiving a command from the host computing device indicating a workload. The method may also include coordinating with the first other storage device to share the workload indicated in the command. The coordinating may occur via direct communications through the first communication port, via the first serial communication link and through the third communication port at the first other storage device.

### Example 30

The method of example 29, the workload may include a filtering operation or a search string for data stored to one or more memory devices maintained at the storage device and stored to one or more memory devices maintained at the first other storage device.

### Example 31

The method of example 19, receiving the indication that at least one other storage device, programmable logic or ASIC has coupled with the storage device through the first communication port may include the indication that a first programmable logic has coupled through the first communication port.

### Example 32

The method of example 31, the first programmable logic may include a front-end logic to enable the storage device to communicate through the second communication port using a communication protocol not supported by a storage controller logic for the storage device.

### Example 33

The method of example 32, the communication protocol may include one of an Ethernet communication protocol, a QPI communication protocol or an Infiniband communication protocol.

### Example 34

The method of example 18, receiving the indication that at least one other storage device, programmable logic or ASIC has coupled with the storage device through the first communication port may include the indication that a first ASIC has coupled through the first communication port.

### Example 35

The method of example 34 may also include receiving a command from the host computing device indicating a workload to be performed on data to be written to or read from one or more memory devices maintained at the storage device. The method may also include offloading at least a portion of the workload to the first ASIC. For these examples, the at least a portion of the workload may include encryption of the data, decryption of the data, compression of the data, decompression of the data, a filter operation on the data or a search string associated with the data.

### Example 36

The method of example 18, the storage device may be a solid state drive (SSD) having multiple non-volatile memory devices. The multiple non-volatile memory devices may be accessible to the host computing device through the second communication port and accessible to the at least one storage device, programmable logic or ASIC through the first communication port.

### Example 37

The method of example 36, the non-volatile memory devices may include the one or more memory devices including one or more types of non-volatile memory to include 3D cross-point memory, flash memory, ferroelectric memory, SONOS memory, polymer memory, ferroelectric polymer memory. FETRAM, FeRAM, ovonic memory, nanowire, EEPROM, phase change memory, memristers or STT-MRAM.

### Example 38

An example at least one machine readable medium may include a plurality of instructions that in response to being executed by system at a storage device may cause the system to carry out a method according to any one of examples 18 to 37.

### Example 39

An example apparatus may include means for performing the methods of any one of examples 18 to 37.

### Example 40

An example system may include a processor for a host computing device. The system may also include a storage device coupled with the computing platform. The storage device may include one or more memory devices. The storage device may also include a first communication port arranged to couple with the processor. The storage device may also include a second communication port. The storage device may also include a storage controller that includes logic, at least a portion of which is in hardware. The logic may control access to the one or more memory devices, configure the second communication port to couple in communication with at least one other storage device, programmable logic or an ASIC and communicate directly with the at least one other storage device, programmable logic or ASIC responsive to an indication that the at least one other storage device, programmable logic or ASIC has coupled through the second communication port.

### Example 41

The system of example 40, the first and second communication ports may be arranged to use a same communication protocol. For these examples, the same communication protocol may include a PCIe or an NVMe communication protocol.

### Example 42

The system of example 40, the first and second communication ports may be arranged to use different serial communication protocols. The second communication port may be arranged to use a first serial communication protocol including one of an Ethernet communication protocol, a QPI communication protocol, an Infiniband communication protocol or a USB communication protocol. The first communication port may be arranged to use a second communication protocol including a PCIe or an NVMe communication protocol.

### Example 43

The system of example 40, the logic included in the storage controller may also receive a first indication that a first other storage device has coupled through the second communication port.

### Example 44

The system of example 43, the first other storage device may have a fourth communication port configured such that the first other storage device is capable of coupling to a second other storage device through the fourth communication port via a second serial communication link responsive to the second other storage device coupling via the second serial communication link. For these examples, the logic included in the storage controller may also receive a second indication that the second other storage device has coupled to the first other storage devices. The logic to communicate directly with the at least one other storage device includes the logic to communicate directly with the second other storage device through the second communication port via the first serial communication link and through the third communication port then through the fourth communication port via the second serial communication link.

### Example 45

The system of example 44, the logic may also receive a command from the processor via the first communication port. The logic may also determine the command is addressed to the first other storage device. The logic may also forward the command to the first other storage device through the second communication port via the first serial communication link.

### Example 46

The system of example 44, the first other storage device may have a fourth communication port configured such that the first other storage device is capable of coupling to a second other storage device through the fourth communication port via a second serial communication link. The logic to communicate directly with the at least one other storage device includes the logic to communicate directly with the second other storage device through the second communication port via the first serial communication link and through the third communication port then through the fourth communication port via the second serial communication link.

### Example 47

The system of example 46, the second other storage device may have a fifth communication port configured such that the second other storage device is capable of coupling to the processor or to the second other storage device through the fifth communication port via the second serial communication link.

### Example 48

The system of example 47, the logic may also receive a response to a command from the first other storage device via the second communication port, the command originating from the processor. The logic may also forward the response to the command to the processor through the first communication port responsive to the command originating from the processor.

### Example 49

The system of example 43, the first other storage device may have a third communication port configured to directly couple with the storage device through the second communication port via the first serial communication link. The logic to communicate directly with the at least one other storage device may include the logic to communicate directly with the first other storage device through the second communication port, via the first serial communication link and through the third communication port at the first other storage device.

### Example 50

The system of example 49, the logic may also receive a command from the host computing device indicating a workload. The logic may also coordinate with the first other storage device to share the workload indicated in the command. The coordination may occur via direct communications through the second communication port, via the first serial communication link and through the third communication port.

### Example 51

The system of example 50, the workload may include a filter operation or a search string for data stored to the one or more memory devices and stored to at least one memory device maintained at the first other storage device.

### Example 52

The system of example 40, the logic included in the storage controller may also receive an indication that a first programmable logic has coupled through the second communication port.

### Example 53

The system of example 52, the first programmable logic may be a front-end logic to enable the storage device to communicate through the programmable logic using a communication protocol not supported by a storage controller logic for the storage device.

### Example 54

The system of example 53, the communication protocol may include one of an Ethernet communication protocol, a quickpath interconnect (QPI) communication protocol or an Infiniband communication protocol.

### Example 55

The system of example 40, the logic included in the storage controller may also receive an indication that a first ASIC has coupled through the second communication port.

### Example 56

The system of example 55, comprising the logic may also receive a command from the host computing device that indicates a workload to be performed on data to be written to or read from the one or more memory devices. The logic may also offload at least a portion of the workload to the first ASIC. The at least a portion of the workload may include encryption of the data, decryption of the data, compression of the data, decompression of the data, a filter operation on the data or a search string associated with the data.

### Example 57

The system of example 40, the one or more memory devices may include the one or more memory devices including one or more types of non-volatile memory to include 3D cross-point memory, flash memory, ferroelectric memory, SONOS memory, polymer memory, ferroelectric polymer memory. FETRAM, FeRAM, ovonic memory, nanowire, EEPROM, phase change memory, memristers or STT-MRAM.

### Example 58

The system of example 40 may also include a digital display coupled with the processor to present a user interface view.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
one or more memory devices;
a first communication port arranged to couple with a host computing device;
a second communication port; and
a storage controller that includes logic, at least a portion of which is in hardware, the logic to:
control access to the one or more memory devices;
configure the second communication port to couple in communication with at least one other storage device, programmable logic or an application-specific integrated circuit (ASIC); and
communicate directly with the at least one other storage device, programmable logic or ASIC responsive to an indication that the at least one other storage device, programmable logic or ASIC has coupled through the second communication port.

2. The apparatus of claim 1, comprising the logic to:
receive a first indication that a first other storage device has coupled through the second communication port.

3. The apparatus of claim 2, comprising the first other storage device has a third communication port configured to directly couple with the storage device through the second communication port via a first serial communication link, the logic to communicate directly with the at least one other storage device includes the logic to communicate directly with the first other storage device through the second communication port, via the first serial communication link and through the third communication port at the first other storage device.

4. The apparatus of claim 3, comprising the logic to:
receive a command from the host computing device indicating a workload; and
coordinate with the first other storage device to share the workload indicated in the command, the coordination to occur via direct communications through the second communication port, via the first serial communication link and through the third communication port at the first other storage device.

5. The apparatus of claim 4, the workload comprising a filter operation or a search string for data stored to the one or more memory devices and stored to at least one memory device maintained at the first other storage device.

6. The apparatus of claim 1, comprising the logic to:
receive an indication that a first programmable logic has coupled through the second communication port.

7. The apparatus of claim 6, the first programmable logic comprising a front-end logic to enable the storage device to communicate through the first communication port using a communication protocol not supported by a storage controller logic for the storage device.

8. The apparatus of claim 7, the communication protocol including one of an Ethernet communication protocol, a quickpath interconnect (QPI) communication protocol or an Infiniband communication protocol.

9. The apparatus of claim 1, comprising the logic to:
receive an indication that a first ASIC has coupled through the second communication port.

10. The apparatus of claim 9, comprising the logic to:
receive a command from the host computing device that indicates a workload to be performed on data to be written to or read from the one or more memory devices; and
offload at least a portion of the workload to the first ASIC, the at least a portion of the workload to include encryption of the data, decryption of the data, compression of the data, decompression of the data, a filter operation on the data or a search string associated with the data.

11. The apparatus of claim 1, the one or more memory devices including one or more types of non-volatile memory to include 3-dimensional cross-point memory, flash memory, ferroelectric memory, silicon-oxide-nitride-oxide-silicon (SONOS) memory, polymer memory, ferroelectric polymer memory, nanowire, ferroelectric transistor random access memory (FeTRAM or FeRAM), ovonic memory, nanowire, electrically erasable programmable read-only memory (EEPROM), phase change memory, memristers or spin transfer torque-magnetoresistive random access memory (STT-MRAM).

12. A method implemented at a storage device comprising:
configuring, at a processor circuit, a first communication port located at the storage device for coupling with another storage device, programmable logic or an application-specific integrated circuit (ASIC) via a first serial communication link, the first communication port separate from a second communication port that is arranged to couple the storage device with a host computing device;
receiving an indication that at least one other storage device, programmable logic or ASIC has coupled with the storage device through the first communication port; and
communicating directly with the at least one other storage device, programmable logic or ASIC through the first communication port and via the first serial communication link.

13. The method of claim 12, comprising the first and second communication ports arranged to use a same communication protocol, the same communication protocol including a peripheral component interconnect express (PCIe) communication protocol or a non-volatile memory express (NVMe) communication protocol.

14. The method of claim 12, the first and second communication ports arranged to use different serial communication protocols, the first communication port arranged to use a first serial communication protocol including one of an Ethernet communication protocol, a quickpath interconnect (QPI) communication protocol, an Infiniband communication protocol or a universal serial bus (USB) communication protocol, the second communication port arranged to use a second communication protocol including a peripheral component interconnect express (PCIe) communication protocol or a non-volatile memory express (NVMe) communication protocol.

15. The method of claim 12, receiving the indication that at least one other storage device, programmable logic or ASIC has coupled with the storage device through the first communication port comprises receiving a first indication that a first other storage device has coupled through the first communication port.

16. The method of claim 15, comprising the first other storage device having a third communication port configured such that the first other storage device is capable of coupling to the host computing device or to the storage device through the third communication port, communicating directly with the at least one other storage device includes the storage device communicating directly with the first other storage device through the first communication port, via the first serial communication link and through the third communication port.

17. The method of claim 16, comprising:
receiving a command from the host computing device through the second communication port;
determining the command is addressed to the first other storage device; and
forwarding the command to the first other storage device through the first communication port via the first serial communication link.

18. The method of claim 16, comprising the first other storage device having a fourth communication port configured such that the first other storage device is capable of coupling to a second other storage device through the fourth communication port via a second serial communication link responsive to the second other storage device coupling via the first serial communication link, communicating directly with the at least one other storage device includes:
receiving a second indication that the second other storage device has coupled to the first other storage device; and
communicating directly with the second other storage device through the first communication port via the first serial communication link and through the third communication port then through the fourth communication port via the second serial communication link.

19. The method of claim 18, comprising the second other storage device having a fifth communication port configured such that the second other storage device is capable of coupling to the host computing device or to the second other storage device through the fifth communication port via the second serial communication link.

20. The method of claim 19, comprising:
receiving a command from the host computing device via the second communication port;
determining the command is addressed to the second other storage device; and
forwarding the command to the first other storage device through the first communication port via the first serial communication link, the command then forwarded by the first other storage device to the second other storage device through the fourth communication port via the second serial communication link.

21. A system comprising:
a processor for a host computing device;
a storage device coupled with the computing platform, the storage device including:
one or more memory devices;
a first communication port arranged to couple with the processor;
a second communication port; and
a storage controller that includes logic, at least a portion of which is in hardware, the logic to:
control access to the one or more memory devices;
configure the second communication port to couple in communication with at least one other storage device, programmable logic or an application-specific integrated circuit (ASIC); and
communicate directly with the at least one other storage device, programmable logic or ASIC responsive to an indication that the at least one other storage device, programmable logic or ASIC has coupled through the second communication port.

22. The system of claim 21, comprising the logic included in the storage controller to:
receive a first indication that a first other storage device has coupled through the second communication port.

23. The system of claim 22, comprising the first other storage device has a third communication port configured to directly couple with the storage device through the second communication port via the first serial communication link, the logic to communicate directly with the at least one other storage device includes the logic to communicate directly with the first other storage device through the second communication port, via the first serial communication link and through the third communication port at the first other storage device.

24. The system of claim 23, comprising the logic to:
receive a command from the host computing device indicating a workload; and
coordinate with the first other storage device to share the workload indicated in the command, the coordination to occur via direct communications through the second communication port, via the first serial communication link and through the third communication port.

25. The system of claim 21, the one or more memory devices including the one or more memory devices including one or more types of non-volatile memory to include 3-dimensional cross-point memory, flash memory, ferroelectric memory, silicon-oxide-nitride-oxide-silicon (SONOS) memory, polymer memory, ferroelectric polymer memory, nanowire, ferroelectric transistor random access memory (FeTRAM or FeRAM), ovonic memory, nanowire, electrically erasable programmable read-only memory (EEPROM), phase change memory, memristers or spin transfer torque-magnetoresistive random access memory (STT-MRAM).
